(19) United States
(12) Patent Application Publication
(10) Pub. No.: US 2021/0136873 A1
(43) Pub. Date: May 6, 2021

(54) ELECTRICAL HEATING DEVICE

(71) Applicant: Webasto SE, Stockdorf (DE)

(72) Inventors: MARTIN ZOSKE, Stockdorf (DE); VOLODOMYR ILCHENKO, Stockdorf (DE); UWE STRECKER, Stockdorf (DE); NIKOLAUS GERHARDT, Stockdorf (DE); MICHAEL SCHWANECKE, Stockdorf (DE); VITALI DELL, Stockdorf (DE); BENGT MEIER, Stockdorf (DE)

(21) Appl. No.: 16/606,337

(22) PCT Filed: Mar. 13, 2018
(86) PCT No.: PCT/EP2018/056179

§ 371 Date: Oct. 18, 2019

(30) Foreign Application Priority Data
Apr. 20, 2017 (DE) 10 2017 108 404.5

(51) Int. Cl. H05B 1/02; H01H 39/00; B60H 1/22

(52) U.S. Cl. CPC H05B 1/0236; H01H 39/006; B60H 2001/2231; H05B 2203/023; B60H 1/2218

(57) ABSTRACT

An electrical heating device, in particular for a vehicle, includes a heat exchanger body, with a heat transfer surface and an at least partially closed cavity. The at least partially closed cavity has a wall section that at least partially delimits the at least partially closed cavity that is adjacent to the heat transfer surface. A pyrotechnical charge is arranged in the at least partially closed cavity, and the at least partially closed cavity has a further wall section delimiting the at least partially closed cavity at least partially and to which an electrical connection line of the electrical heating device is adjacent.

This application represents the national stage entry of PCT International Application No. PCT/EP2018/056179 filed Mar. 13, 2018, which claims priority to German Patent Application 10 2017 108 404.5 filed Apr. 20, 2017, both of which are hereby incorporated herein by reference for all purposes.

This disclosure relates to an electrical heating device, in particular for a vehicle.

Modern motor vehicles, in particular motor vehicles which do not have a fuel-driven internal combustion engine and are electrically driven, often comprise electrical heating devices in order to provide the heat required for vehicle interior air conditioning. Such electrical heating devices have a high heating capacity so that appropriate precautions must be taken for safe operation and for possible malfunctions of the electrical heating devices.

The present disclosure is based on the object of providing an electrical heating device which is reliably deactivated in case of defects.

This object is solved with an electrical heating device comprising the features of the independent claim. Advantageous embodiments of the electrical heating device are indicated in the dependent claims.

An electrical heating device is described, in particular for a vehicle. The electrical heating device comprises a heat exchanger body with a heat transfer surface. At the heat transfer surface a medium to be heated can be present and/or heat from an electrical heating unit, for example a heating layer, can be induced. Indirect contact with the heating layer may be sufficient, for example via heat-conducting copper strands which form the electrical contact with the heating layer. The heat transfer surface is a surface of the heat exchanger body on which heat is induced into or discharged from the heat exchanger body depending on a present temperature gradient. The electrical heating device also comprises an at least partially closed cavity, wherein the at least partially closed cavity having a wall section that partially delimits the at least partially closed cavity and that is adjacent to the heat transfer surface. The term “adjacent to” can here be understood as meaning that the wall section partially delimiting the at least partially closed cavity on its side facing away from the at least partially closed cavity forms a part of the heat transfer surface at which the medium to be heated is present and/or generated heat is induced. A pyrotechnical charge is arranged in the at least partially closed cavity. Furthermore, it is provided that the at least partially closed cavity has a further wall section delimiting the at least partially closed cavity (20) at least partially and to which an electrical connection line of the electrical heating device is adjacent. The term “adjacent to” can here be understood as meaning that the electrical connection line runs on the side of the further wall section facing away from the cavity or, alternatively, that the further wall section is formed by the electrical connection line itself. An at least partially closed cavity is a cavity which can still have openings in some places in wall sections delimiting it, for example in form of gaps at or between the edges of individual wall sections.

In particular, the pyrotechnical charge can be a temperature-sensitive material which reacts chemically spontaneously when an ignition temperature is reached, releasing gas and solid particles. As the chemical reaction takes place, for example, 10% gases and 90% solid particles can be released as reaction products. In particular, the chemical reaction that releases gases and solid particles can lead to a sharp pressure rise within the at least partially closed cavity, resulting in bursting of the cavity, wherein the electrical connection line being interrupted by a bulging of the further wall section during the bursting of the at least partially closed cavity. The pressure rise is achieved by the thermal energy released during the chemical reaction, which heats the gas present in the at least partially closed cavity, and the reaction products released during the chemical reaction, in particular the released gas. By interrupting the electrical connection line, the electrical heating device can be reliably disconnected from a power supply and thus taken out of operation if a temperature threshold defined by the pyrotechnical charge, the ignition temperature of the temperature-sensitive material, is exceeded. The electrical connection line can be an electrical supply line to one or more heating lines that can be connected in parallel or in series. The heating lines can be designed as conventional ohmic resistors. In particular, materials can be used for the heating lines that do not have any properties counteracting an undesirable rise in temperature. The electrical connection line itself can also be already part of the heating line. The electrical connection line can comprise several individual line paths which can run separately in the area of the further wall section. The temperature threshold at which the temperature-sensitive material reacts is the ignition temperature of the pyrotechnical charge. The ignition temperature of the pyrotechnical charge can be varied, i.e. adjusted, within wide temperature ranges by suitable selection of materials. The ignition temperature of the pyrotechnical charge can, for example, be between 295° C. and 305° C., which corresponds to an average ignition temperature of 300° C. An ignition temperature of around 260° C. is also possible, for example. Of course, the electrical heating device can have several pyrotechnical charges in different at least partially closed cavities, so that electrical connection lines can be interrupted at different positions of the electrical heating device. It is therefore also conceivable, for example, that the electrical connection line may only be interrupted in those areas of the electrical heating device where the temperature actually rises undesirably. It is also possible that only a partial separation of the electrical heating device from the power source is provided in order to enable a power-reduced emergency operation of the electrical heating device.

Furthermore, it may be provided that the pyrotechnical charge is arranged at the wall section that partially delimits the at least partially closed cavity. In this way, an undesired temperature rise due to a malfunction of the electrical heating device can be detected at an early stage and the electrical heating device can be disconnected from the power supply by the pyrotechnical charge.

Furthermore, it may be provided that the further wall section that partially delimits the at least partially closed cavity is opposite to the wall section that partially delimits the at least partially closed cavity. The term “opposite” can in particular be understood to mean that the wall section and the further wall section can be connected by a direct straight line which runs completely within the at least partially closed cavity. In this way, particularly when the pyrotechnical charge is arranged on the wall section, it is particularly easy for the pyrotechnical charge to exert a directional force in the direction of the further wall section in order to be able to disconnect the electrical connection line particularly easily. This allows, for example, the use of a smaller pyrotechnical charge, which increases the safety of the electrical heating device. Alternatively, it is also conceivable that the wall section and the further wall section are not opposite to each other but, for example, form surfaces perpendicular to each other. The force released by the pyrotechnic charge during ignition is then deflected within the at least partially closed cavity, for example at a correspondingly curved wall section, in order to direct it targeted towards the further wall section. Especially due to the required deflection, some larger pyrotechnical charge may be necessary. However, the deflection allows the electrical heating device to be designed more freely.

Advantageously it may be provided that the at least partially closed cavity is at least partially formed within the heat exchanger body. In this way, a particularly efficient thermal connection of the wall section to the heat transfer surface can be achieved. Furthermore in this way, the fabrication of the at least partially closed cavity, in which the pyrotechnical charge is arranged, can be simply designed, since a simple indentation on the outer surface of the heat exchanger body, in which the pyrotechnical charge is arranged and which is subsequently closed, can already be sufficient.

It may be provided that the at least partially closed cavity is located between the heat transfer surface and a further heat transfer surface at which electrically generated heat is induced into the heat exchanger body. This arrangement allows a particularly compact design of the electrical heating device, in which the electrical connection line can be arranged in the area of the further heat transfer surface. The further heat transfer surface is a surface of the heat exchanger body at which heat is induced into or discharged from the further heat exchanger body depending on an existing temperature gradient.

Advantageously it may be provided that the at least partially closed cavity is at least partially formed outside of the heat exchanger body in a cover that also guides the electrical connection line. In this way, the electrical heating device can, if necessary, be repaired after disconnection from the power supply by triggering the pyrotechnical charge by replacing the cover and installing a new pyrotechnical charge. It is therefore not necessary to replace the entire electrical heating device after a defect. Furthermore, the required at least partially closed cavity can easily be realised with the help of the cover, especially if this cavity is partly realised in the heat exchanger body and partly in the cover. The cover can be cork-shaped and can be jammed in the depression in the heat exchanger body which forms the other walls of the at least partially closed cavity.

It may be provided that the further wall section that partially delimits the at least partially closed cavity is at least partially bordered by predetermined breaking points. The provision of predetermined breaking points limiting the further wall section facilitates the controlled cutting through of the electrical connection line which is adjacent to the further wall section. A smaller pyrotechnical charge can also be used, as the force required to bulge the further wall section is less.

Advantageously it may be provided that the electrical connection line comprises at least one line's predetermined breaking point that is located in a region of the electrical connection line that is adjacent to the further wall section that partially delimits the at least partially closed cavity. In this way, a controlled disconnection of the electrical connection line can be achieved when the further wall section bulges after the pyrotechnical charge has been triggered.

It may be provided that an anvil is located within the at least partially closed cavity between the pyrotechnical charge and the further wall section that partially delimits the at least partially closed cavity. The anvil can be accelerated towards the further wall section by the temperature-induced triggering of the pyrotechnical charge and the thereby produced gases and solid particles which flow in the direction of the anvil, whereby the bulging of the further wall section can be supported. The anvil can be made of an electrically insulating material. An electrically insulating anvil can, especially if it at least partially penetrates the further wall section and/or remains stuck in this wall section, contribute to a particularly reliable and rapid disconnection of the electrical connecting line, which occurs in particular without the temporary formation of arcs.

Advantageously it may be provided that the pyrotechnical charge is located within a primer. A primer is a standard component that is available in standard sizes at low cost, so that manufacturing costs and, if necessary, maintenance costs if the primer needs to be replaced can be low. The primer can, for example, be located jammed in the at least partially closed cavity.

This disclosure is described in the following with reference to the accompanying drawings on the basis of preferred embodiments.

It shows:

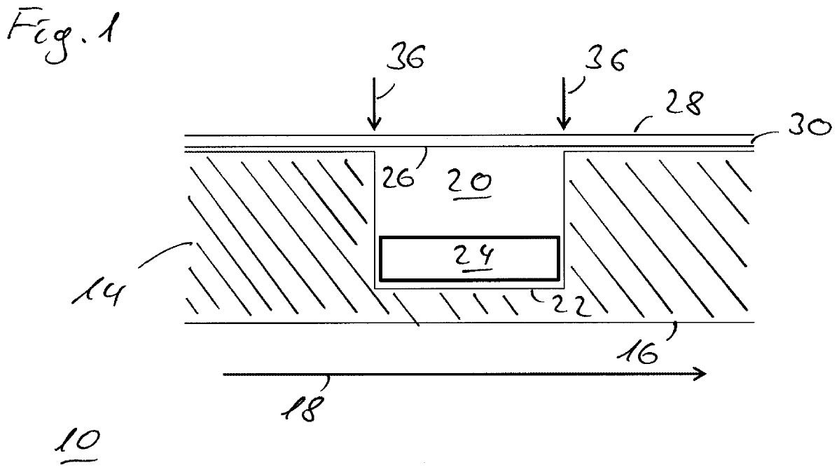

FIG. 1 a first sectional view of a section of a first electrical heating device;

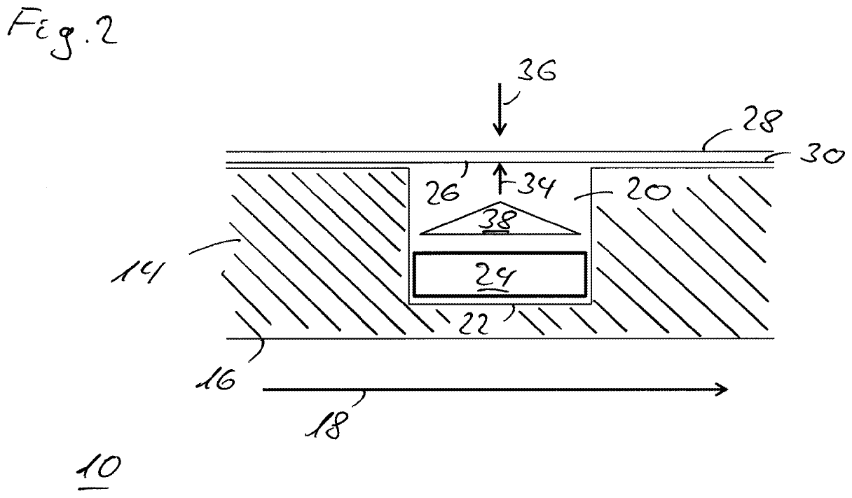

FIG. 2 a second sectional view of a section of a second electrical heating device;

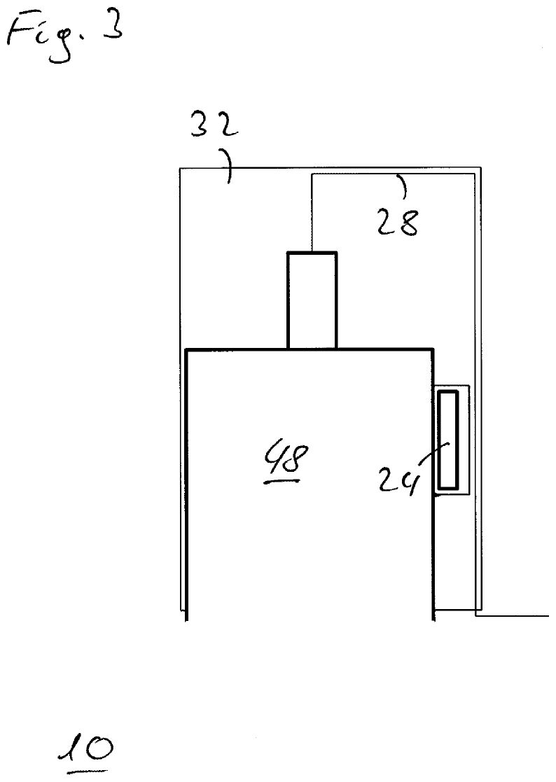

FIG. 3 a third sectional view of a section of a third electrical heating device;

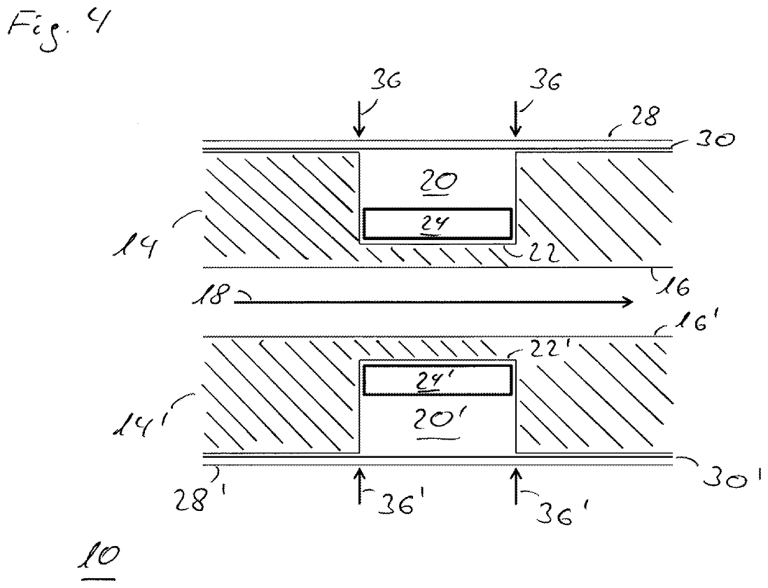

FIG. 4 a fourth sectional view of a section of a fourth electrical heating device;

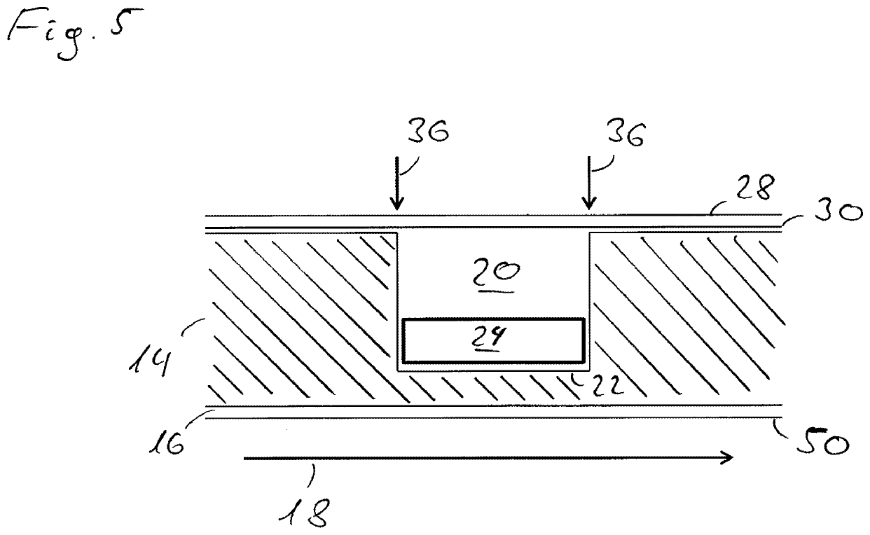

FIG. 5 a fifth sectional view of a section of a fifth electrical heating device;

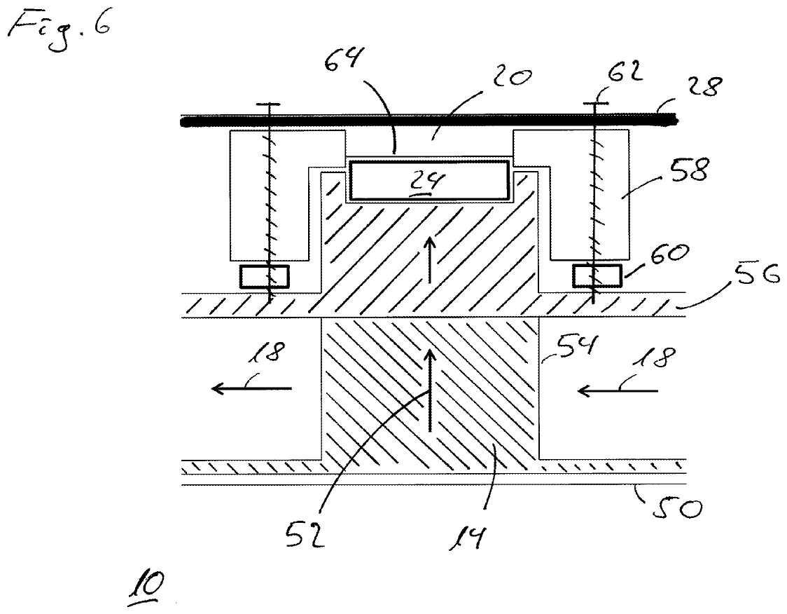

FIG. 6 a sixth sectional view of a section of a sixth electrical heating device; and

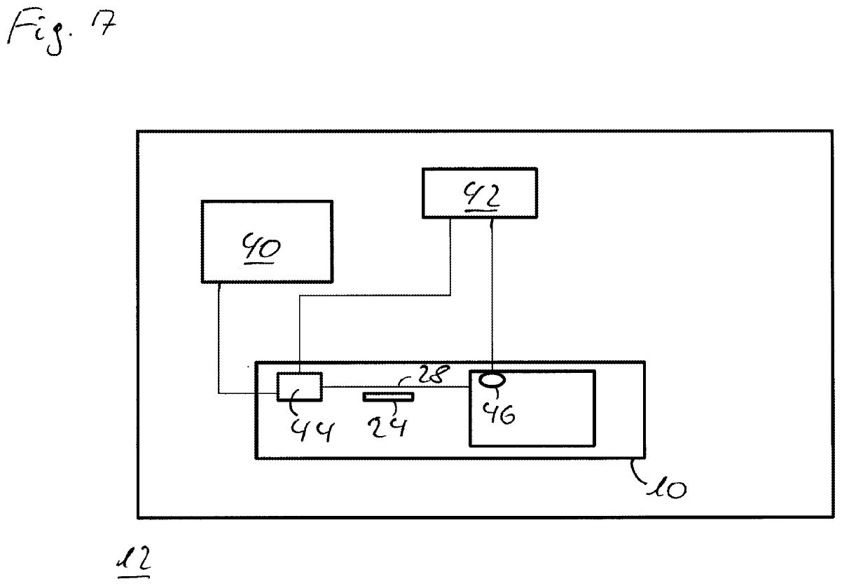

FIG. 7 a schematic representation of a vehicle with an electrical heating device.

In the following description of the drawings, identical reference numerals denote identical or comparable parts. Unless otherwise stated in the description, gaps visible in the drawings between two adjacent components may be regarded as illustrating the boundaries between the individual components shown. Therefore, such gaps only serve to make the representation clearer.

FIG. 1 shows a first sectional view of a section of a first electrical heating device. In the section of the electrical heating device 10 shown, a section of a heat exchanger body 14 can be seen hatched. In FIG. 1, in the lower area below the heat exchanger body 14, a medium 18 can flow along the heat exchanger body 14, so that the surface of the heat exchanger body 14 there represents a heat transfer surface 16. In FIG. 1, in the upper part, an electrical connection line 28 is shown, which is arranged on a further heat transfer surface 30 of the heat exchanger body 14. The further heat transfer surface 30 can, for example, be an integral part of the heat exchanger body 14 as a plate-like cover. It is also possible that the further heat transfer surface 30 only designates the surface of the heat exchanger body 14 on which the electrical connection line 28 is arranged. The electrical connecting line 28 can, for example, also include one or more heating wires designed as ohmic resistors or lead to them. The electrical connection line 28 can, for example, be designed as a punched grid. It is also possible that the electrical connection line 28 is mounted on a foil carrier, for example by lamination, and that this foil carrier is connected flatly to the heat exchanger body 14, for example by gluing. In addition, line's predetermined breaking points 36 are marked by arrows, at which the electrical connection line 28 is interrupted when a pyrotechnical charge 24 is triggered. Line's predetermined breaking points 36 can, for example, be realized as bracket edges or in another way known to the person skilled in the art. The pyrotechnical charge 24 is arranged on a wall section 22, which partially delimits an at least partially closed cavity 20. The wall section 22 is adjacent to the heat transfer surface 16. The at least partially closed cavity 20 is initially designed as an indentation in the heat exchanger body 14, which is initially open to the outside in order to be able to jam the pyrotechnical charge 24, which can for example be designed as a primer, in the outwardly open indentation on the wall section 22. The indentation in the heat exchanger body 14 can then be closed off to the outside by, for example, a plate-like further heat transfer surface 30 that is firmly connected to the heat exchanger body 14 in order to form the at least partially closed cavity 20. The part which closes the indentation in the heat exchanger body 14 in the direction of the electrical connection line 28 then forms the further wall section 26. It is also conceivable to insert a cork-like insert into the indentation to close off the indentation and form the at least partially closed cavity 20. The electrical connection line 28 can then be arranged on the further heat transfer surface 30, for example provided with line's predetermined breaking points 36.

The heat exchanger body 14 normally reaches an operating temperature between 120° C. and 130° C. at the heat transfer surface 16. It may be provided that the electrical heating device 10 tolerates an increased temperature of, for example, up to 230° C. in the short term. A corresponding switch-off device, which realizes a non-destructive deactivation of the electrical heating device at this temperature to be tolerated in the short term, is sketched in the following in connection with FIG. 7. The pyrotechnical charge 24 is designed such that it reacts at a nominal ignition temperature of 300° C. The charge-dependent low scattering of the ignition temperatures, which is usual with such pyrotechnical charges, results in a chemical reaction of the pyrotechnic charge, which starts, for example, between 295° C. and 305° C. As soon as the pyrotechnic charge 24 ignites, a large quantity of gases and particles is released within the at least partially closed cavity 20 and, due to the arrangement of the pyrotechnic charge 24 on wall section 22, is bundled essentially in the direction of the further wall section 26, so that the latter is bulged there or the further wall section 26 is completely blown off. Thereby, the electrical connecting line 28, in particular at the desired line's predetermined breaking points 36, is severed so that the electrical heating device 10 is disconnected from a power supply. In this way, a further rise in temperature within the electrical heating device 10 can be prevented. The pyrotechnical charge 24 can, for example, be designed as a standardized primer. The diameter of the primer can, for example, be 5.33 mm (large riffle) or 4.45 mm (small riffle). The primer used may, for example, contain 20 mg of a pyrotechnical solid mass which reacts spontaneously when an ignition temperature between 295° C. and 305° C. is reached, releasing gases and solids (e.g. 10% gases and 90% solids).

FIG. 2 shows a second sectional view of a section of a second electrical heating device. The structure of the visible section of the electrical heating device 10 is largely identical to that of the electrical heating device 10 already known from FIG. 1. However, an anvil 38 is recognizable in the at least partially closed cavity 20 between the pyrotechnical charge 24 and the further wall section 26. In addition, the line's predetermined breaking point 36 shown in FIG. 2 is arranged opposite to a predetermined breaking point 34 in the further wall section 26 on the further wall section 26. As an alternative to the arrangement of the predetermined breaking point 34 shown in FIG. 2, it can be arranged in particular at the edge of the further wall section 26 and at least partially delimit the further wall section 26. Similarly, the line's predetermined breaking point 36 can also be arranged at the edge opposite to the predetermined breaking point 34 then arranged there.

When the pyrotechnical charge 24 reaches its ignition temperature, the anvil 38 is accelerated towards the further wall section 26 by the released gases and solid particles. The anvil 38 can bulge up the further wall section 26 or completely blast it off. Thereby in particular, the predetermined breaking point 34 and the line's predetermined breaking point 36 can promote the bulging of the further wall section 26. The anvil 38 can, for example, consist of an electrically insulating material or at least include one on its side facing the further wall section 26, for example as a coating, and remain stuck in the further wall section 26 after the bulging of the further wall section 26, so that an additional mechanical barrier at the passage points, i.e. the predetermined breaking point 34 and the line's predetermined breaking point 36, interrupts the electrical connection line 28 by the anvil 38. The anvil 38 can be an integral part of a primer that carries the pyrotechnical charge 24. The anvil 38 can, however, also be independent of a carrier of the pyrotechnical charge designed as a primer. Anvil 38 and/or primer may also be used in addition and/or as carriers of the pyrotechnical charge 24 at the other electrical heating devices shown.

FIG. 3 shows a third sectional view of a section of a third electrical heating device. The heating device 10 shown in FIG. 3 is provided with a cover 32 which, like an end cap, guides an electrical connection line 28 running in this area. The cover 32 can, for example, be an end cap of a heating coil 48, which is then to be regarded in the usual way as a heat exchanger body in whose interior ohmic resistances are arranged. The outer surface of the heating coil 48 is to be regarded as heat transfer surface 16, along which medium to be heated can flow at least in an area not shown in the figure. An at least partially closed cavity with a pyrotechnical charge 24 can be provided between the electrical connecting line 28 and the heating coil 48, analogous to the electrical heating devices 10 shown in FIGS. 1 and 2. When the ignition temperature of the pyrotechnical charge 24 is reached, the electrical connection line 28 is also cut through in the area of the cover 32 of the electrical heating device 10 shown in FIG. 3. By attaching a new cover 32, which in particular may also include an intact electrical connecting line 28 and a new pyrotechnical charge 24, the electrical heating device 10 shown in FIG. 3 can be repaired particularly easily after the pyrotechnical charge 24 has been triggered.

FIG. 4 shows a fourth sectional view of a section of a fourth electrical heating device. The electrical heating device 10 shown in FIG. 4 is based on the electrical heating device 10 shown in FIG. 1. A second heat exchanger body 14′ can be seen below the heat exchanger body 14, whose second heat transfer surface 16′ forms a flow channel for the medium 18 with the heat transfer surface 16. The function and arrangement of the other components in and at the second heat exchanger body 14′ largely correspond to the components named in FIG. 1. A second electrical connection line 28′ is shown which is arranged on a second further heat transfer surface 30′ of the second heat exchanger body 14′. The second further heat transfer surface 30′, for example, can again be an integral part of the second heat exchanger body 14′ as a plate-like cover. Again, it is also possible that the second further heat transfer surface 30′ designates only the surface of the second heat exchanger body 14′, on which the second electrical connection line 28′ is arranged. The second electrical connection line 28′ can also include one or more heating lines in the form of ohmic resistors or lead to them. The second electrical connection line 28′ can, for example, be designed again as a punched grid. It is also again possible that the second electrical connection line 28′ is applied to a foil carrier, for example by lamination, and this foil carrier is connected flatly to the second heat exchanger body 14′, for example by gluing. Furthermore, further line's predetermined breaking points 36′ are marked by arrows, at which the second electrical connection line 28′ is interrupted when a second pyrotechnical charge 24′ is triggered. The further line's predetermined breaking points 36′ can, for example, be implemented as bracket edges or in another way known to the person skilled in the art. The second pyrotechnical charge 24′ is arranged on a second wall section 22′, which partly delimits a second at least partially closed cavity 20′. The second wall section 22′ is adjacent to the second heat transfer surface 16′. The second at least partially closed cavity 20′ is fabricated as an indentation in the second heat exchanger body 14′ in the beginning, which is initially open to the outside, in order to be able to jam the second pyrotechnical charge 24′, which can be fabricated, for example, as a primer, in the indentation open to the outside at the second wall section 22′. The indentation in the second heat exchanger body 14′ can then be closed off to the outside for example by a plate-like second heat transfer surface 30′ that can be firmly connected to the second heat exchanger body 14′ in order to form the second at least partially closed cavity 20′. The part which closes the indentation in the second heat exchanger body 14′ in the direction of the second electrical connection line 28′ then forms the second further wall section 26′. It is also possible to insert a cork-like insert into the indentation to close off the indentation and form the second at least partially closed 20′ cavity. The second electrical connecting line 28′ can then be arranged on the second heat transfer surface 30′, e.g. provided with the further line's predetermined breaking points 36′. The triggering of the pyrotechnical charge 24 and the second pyrotechnical charge 24′ takes place independently of each other and is exclusively temperature-dependent. In this way, for example, the electrical heating device 10 can be partially separated from the energy source if only one of the two pyrotechnical charges 24, 24′ triggers.

FIG. 5 shows a fifth sectional view of a section of a fifth electrical heating device. The electrical heating device 10 shown in FIG. 5 is also based on the electrical heating device 10 shown in FIG. 1. However, in the lower part of the figure a heating layer 50 is visible, which is arranged at the heat transfer surface 16. The heating layer 50 directly heats the passing medium 18 and can be connected to the power source, which is not shown, in a manner also not shown via the electrical connection line 28. It is also possible that medium to be heated also flows above the heat exchanger body 14 in order to further improve the efficiency of the electrical heating device 10. If an undesirable and intolerable temperature increase occurs at the heating layer 50, the wall section 22 is heated due to the heat flow and the pyrotechnical charge 24 reacts. As a result, the electrical connecting line 28 is cut through at the predetermined breaking points 36 and the electrical heating layer 50 is thus permanently separated from the power source. In this way, further heating of the electrical heating device 10 can be permanently and reliably ruled out, as it is functionless until it is repaired.

FIG. 6 shows a sixth sectional view of a section of a sixth electrical heating device. In the electrical heating device shown in FIG. 6, the heat exchanger body 14 is supplemented by a channel cover 56. Between the heat exchanger body 14 and the channel cover 56, the medium to be heated, which can be liquid or gaseous for example, is guided. For example, the channel cover 56 can be firmly connected to the heat exchanger body 14, in particular with a firmly bonded connection. A firmly bonded connection can, for example, be made by welding the channel cover 56 to the heat exchanger body 14. The channel cover can therefore be regarded as an integral part of the heat exchanger body 14. The heating layer 50 is arranged on the heat exchanger body 14. Heat generated by the heating layer 50 can be transferred directly to the channel cover 56 in form of a heat flow 52 via a heat bridge 54. The thermal bridge 54 can be designed, for example, in the form of a cone and, in particular, can provide the shortest possible and most direct thermal connection between the heating layer 50 and the channel cover 56. The thermal bridge 54 can be connected to the channel cover 56 in a firmly bonded manner in order to permit good heat transfer. The channel cover 56, in continuation of the thermal bridge 54, has a molded section which provides a recess for receiving the pyrotechnical charge 24. The recess is part of the at least partially closed cavity 20 and the surface of the recess on which the pyrotechnical charge 24 rests is the heat transfer surface 16 where the heat flow 52 generated by the heating layer 50 exits. The at least partially closed cavity 20 is thus adjacent to the heating layer 50. The mold is surrounded by a molded part 58, which can be made of plastic, for example. The molded part 58 can have a thermally insulating effect. The molded part 58 can have a retaining device 64, which can in particular be web-like, which can fix the pyrotechnical charge 24 in the recess. The molded part 58 is fixed to the channel cover 56 with the aid of fasteners 62. Fasteners 62 can, for example, be designed as screws. The fasteners 62 can engage in the sockets 60 provided for this purpose on the channel cover 56 to ensure that the molded part 58 is fixed in place. The fasteners 62 also serve to fix the electrical connecting line 28. The electrical connecting line 28 can, for example, be designed as a printed circuit board on which electrical lines run which, among other things, serve to supply power to the heating layer 50. Further electronic components of the electrical heating device 28 can also be provided, especially if the electrical connection line 28 is designed as a printed circuit board. Again, the electrical connecting line 28 defines the further wall section which at least partially delimits the cavity 20. The force generated when the pyrotechnical charge 24 is triggered is bundled by the arrangement of the pyrotechnical charge 24 on the opposite side of the at least partially closed cavity 20 in the direction of the further wall section, so that the latter is again mechanically bulged up or destroyed to such an extent that the electrical connection line 28 of the heating layer 50 running in this area is destroyed.

FIG. 7 shows a schematic representation of a vehicle. The vehicle shown schematically in FIG. 7 comprises, in addition to an electrical heating device 10, a power source 40 for supplying the electrical heating device 10 as well as a control unit 42 for controlling the electrical heating device 10. The control unit 42 can in particular control the heating power of the electrical heating device 10 via one or more IGBTs 44. Furthermore, a temperature sensor 46 is provided in the electrical heating device 10 so that the control unit 42 can detect an undesired temperature increase above the normal operating temperature of 120° C. to 130° C. and deactivate the electrical heating device 10, for example in the event of a detected excess temperature of 230° C., without further damage to the electrical heating device 10. IGBTs 44 have the property that they become conductive in the event of a failure caused by a defect. If the IGBT or IGBTs 44 are defective, the control unit 42 cannot regulate the heating power of the electrical heating device 10, so that in particular it is not possible to switch off the electrical heating device 10 when the excess temperature of 230° C. at the temperature sensor 46 is reached. If the temperature in the electrical heating device 10 increases further, the pyrotechnical charge 24 finally reacts when it reaches its ignition temperature of, for example, approximately 300° C. so that the electrical connecting line 28 is disconnected in a controlled manner. The electrical heating device 10 is thus permanently disconnected from the power source 40 until the electrical heating device 10 is repaired or replaced.

The features of the disclosure as described above, in the drawings as well as in the claims can be arranged either individually or in any combination.

### REFERENCE NUMERALS

10 electrical heating device
12 vehicle
14 heat exchanger body
14′ second heat exchanger body
16 heat transfer surface
16′ second heat transfer surface
18 medium
20 at least partially closed cavity
20′ second at least partially closed cavity
22 wall section
22′ second wall section
24 pyrotechnical charge
24′ second pyrotechnical charge
26 further wall section
26′ second further wall section
28 electrical connection line
28′ second electrical connection line
30 further heat transfer surface
30′ second further heat transfer surface
32 cover
34 predetermined breaking point
36 line's predetermined breaking point
36′ further line's predetermined breaking point
38 anvil
40 power source
42 control unit
44 IGBT
46 temperature sensor
48 heating coil
50 heating layer
52 heat flow
54 heat bridge
56 channel covering
58 moulded part
60 socket
62 fastener
64 retaining device

1. Electrical heating device for a vehicle,
comprising a heat exchanger body, with a heat transfer surface and
an at least partially closed cavity,
wherein the at least partially closed cavity has a wall section that at least partially delimits the at least partially closed cavity that is adjacent to the heat transfer surface,
wherein a pyrotechnical charge is arranged in the at least partially closed cavity, and
wherein the at least partially closed cavity has a further wall section delimiting the at least partially closed cavity at least partially and to which an electrical connection line of the electrical heating device is adjacent.

2. The electrical heating device according to claim 1, wherein the pyrotechnical charge is arranged at the wall section that partially delimits the at least partially closed cavity.

3. The electrical heating device according to claim 1, wherein the further wall section that partially delimits the at least partially closed cavity is opposite to the wall section that partially delimits the at least partially closed cavity.

4. The electrical heating device according to claim 1, wherein the at least partially closed cavity is at least partially formed within the heat exchanger body.

5. The electrical heating device according to claim 4, wherein the at least partially closed cavity is located between the heat transfer surface and a further heat transfer surface at which electrically generated heat is induced into the heat exchanger body.

6. The electrical heating device according to claim 1, wherein the at least partially closed cavity is at least partially formed outside of the heat exchanger body in a cover that also guides the electrical connection line.

7. The electrical heating device according to claim 1, wherein the further wall section that partially delimits the at least partially closed cavity is at least partially bordered by predetermined breaking points.

8. Electrical heating device according to claim 1, wherein the electrical connection line comprises at least one line's predetermined breaking point that is located in a region of the electrical connection line that is adjacent to the further wall section that partially delimits the at least partially closed cavity.

9. The electrical heating device according to claim 1, wherein an anvil is located within the at least partially closed cavity between the pyrotechnical charge and the further wall section that partially delimits the at least partially closed cavity.

10. The electrical heating device according to claim 1, wherein the pyrotechnical charge is located within a primer.
